(19) United States
(12) Patent Application Publication
(10) Pub. No.: US 2016/0117939 A1
(43) Pub. Date: Apr. 28, 2016

(54) TIME ACTIVATED AUDIO TEACHING SYSTEM

(71) Applicant: Ricardo Peñaloza, Torrance, CA (US)

(72) Inventor: Ricardo Peñaloza, Torrance, CA (US)

(21) Appl. No.: 14/922,189

(22) Filed: Oct. 25, 2015

Related U.S. Application Data
(60) Provisional application No. 62/068,624, filed on Oct. 25, 2014.

(51) Int. Cl. G09B 5/04

(52) U.S. Cl. CPC G09B 5/04

(57) ABSTRACT

A time activated audio teaching system is disclosed. The time activated audio teaching system is configured to output audio lessons at user specified times. Lessons are preferably audio recordings of native or foreign language words or phrases. The time activated audio teaching system includes a user control interface where a user can control the time activation schedule and what lesson subject to use.

### CROSS-REFERENCE TO RELATED PATENT APPLICATIONS

The present application is related to and claims priority of U.S. provisional patent application (“Copending Provisional Application”), Ser. No. 62/068,624, entitled “TIME ACTIVATED AUDIO TEACHING SYSTEM,” filed on Oct. 25, 2014. The disclosure of the Copending Provisional Application is hereby incorporated by reference in its entirety.

### FIELD OF INVENTION

The present invention relates to the field of education. More specifically, a system that activates to produce audio lessons at a programmed time of day.

### BACKGROUND OF INVENTION

There are many known audio teaching systems; many of these systems are activated by pressing a switch or triggering a sensor. One good example is a common children's interactive toy. The toy is often set to audio output a word or phrase lesson when the child presses a button located on the toy. Sometimes these toys are sound or motion activated to audio output a preprogrammed lesson as well. All these mentioned methods require the user to initiate the activation of the system. This can be a problem in terms of teaching effectiveness if the user forgets or neglects to activate the system. The present invention seeks to provide another activation method for teaching systems

### BRIEF SUMMARY OF THE INVENTION

The present invention comprises a time activated audio system for teaching purposes. The system is configured to be standalone or installed into another housing, such as a doll and includes a speaker, which provides the sound and audio. The entire system is programmed to activate at a set time and schedule by the use of a user control interface. The user control interface allows the user to customize and set the schedule and times the system will activate in addition to allowing the user to control what lesson or lessons will be produced. Power is preferably provided by using replaceable batteries or a rechargeable battery pack.

These and other features of the present invention will become readily apparent upon further review of the following specification and drawings.

### BRIEF DESCRIPTION OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 is a block schematic, showing all the major components of the present invention.

FIG. 2 is a system block diagram, showing how all the major components work together.

FIG. 3 is a schematic view, showing one preferred embodiment of implementing the present invention into a toy or doll.

FIG. 4 is a flowchart, showing one preferred embodiment for a method used by the present invention.

FIG. 5 is a flowchart, illustrating an example of the method shown in FIG. 4.

FIG. 6 is a flowchart, showing another preferred embodiment for another method used by the present invention.

### DETAIL DESCRIPTION OF THE INVENTION

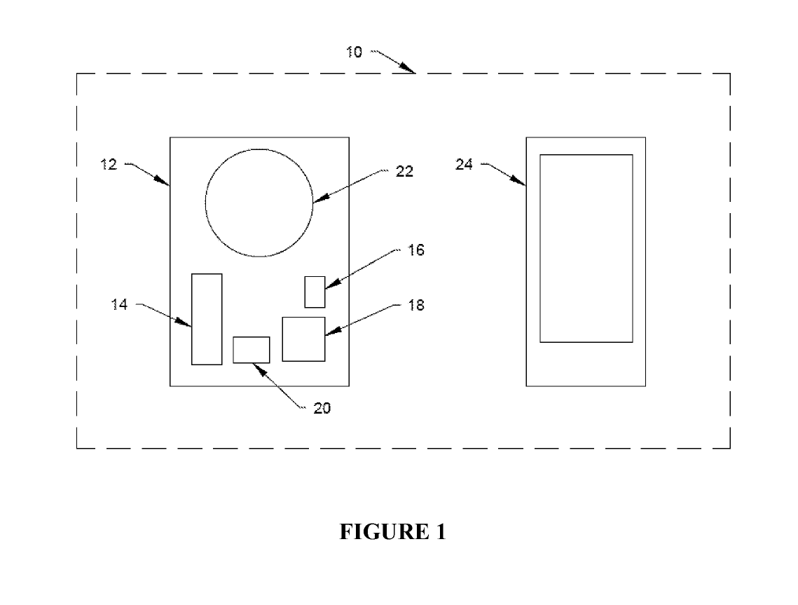

Referring now to FIG. 1, there is shown a simplified block schematic of the time activated audio teaching system 10 in accordance with the present invention. The time activated audio teaching system 10 includes a housing 12, which may be configured to be a standalone unit or installed into another housing, such as a doll. Housing 12 is used to integrate together some of the various subsystem components used by the time activated audio teaching system 10 including: a power supply 14; a communication module 16; control module 18; memory module 20 and speaker 22. The control module 18 provided to control the time activated audio teaching system 10. In one preferred embodiment, control module 18 is preferably a printed circuit board containing suitable electronic components such as a microcontroller, an audio synthesizer, resistors and the like. Additionally, the control module 18 may keep track of time. The communication module 16 is provided to relay information between a user control interface 24 and the control module 18. The communication module 16 may be a USB port, Bluetooth transceiver, Wi-Fi transceiver or the like. The memory module 20 is provided to store data received from the user control interface 24 wherein the user control interface 24 may be the screen of a smartphone, electronic PAD and a laptop or desktop screen and the like. In one preferred embodiment, the memory module 20 may be a circuit board mounted memory chip or a removable memory card and the like. The speaker 22 is provided to emit sound to the user when it receives audio signals from the control module 18. The power supply 14 provides power to the various subsystem components 16, 18, 20 and 22, respectively. The power supply 14 can be replaceable batteries or a rechargeable battery pack and the like. The user control interface 24 provides a user (not shown) a means to customize and control the settings and data of the time activated audio teaching system 10 in accordance with the present invention. The user control interface 24 can transfer data to the control module 18 via the communication module 16. In one preferred embodiment, the user control interface 24 can be a set of buttons wired to the control module 18. It can be a computer and software combination connected through a USB cable to the communication module 16. In the preferred embodiment, it can be a smartphone and mobile application combination connected wirelessly using Wi-Fi or Bluetooth.

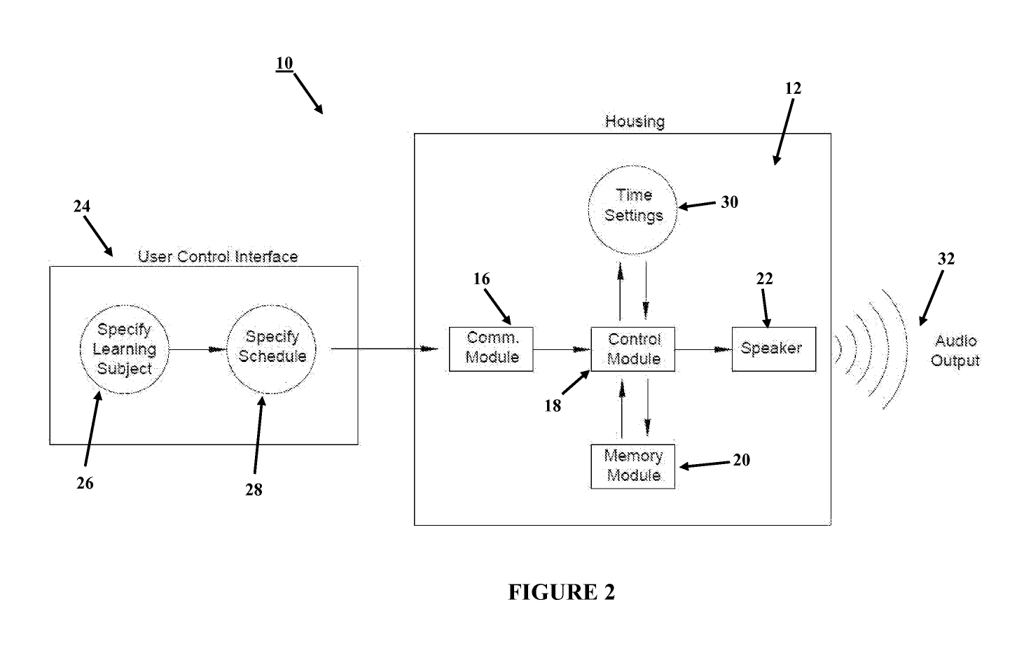

Referring now to FIG. 2, there is shown a system block diagram illustrating the flow from the user control interface 24 all the way to an audio output 32. In use, the user begins the time activated audio teaching system 10 using the user control interface 24 and specifies what subjects to learn 26, specifies a schedule 28 at what time of the day to activate system 10. These inputs or specifications 26 and 28 are then sent to the communication module 16 which is then processed by control module 18 and then stored in the memory module 20. Lastly, the control module 18 will activate and process the specified audio lesson at the specified time 30. The speaker 22 will provide audio output 32 for audio signals sent from the control module 18.

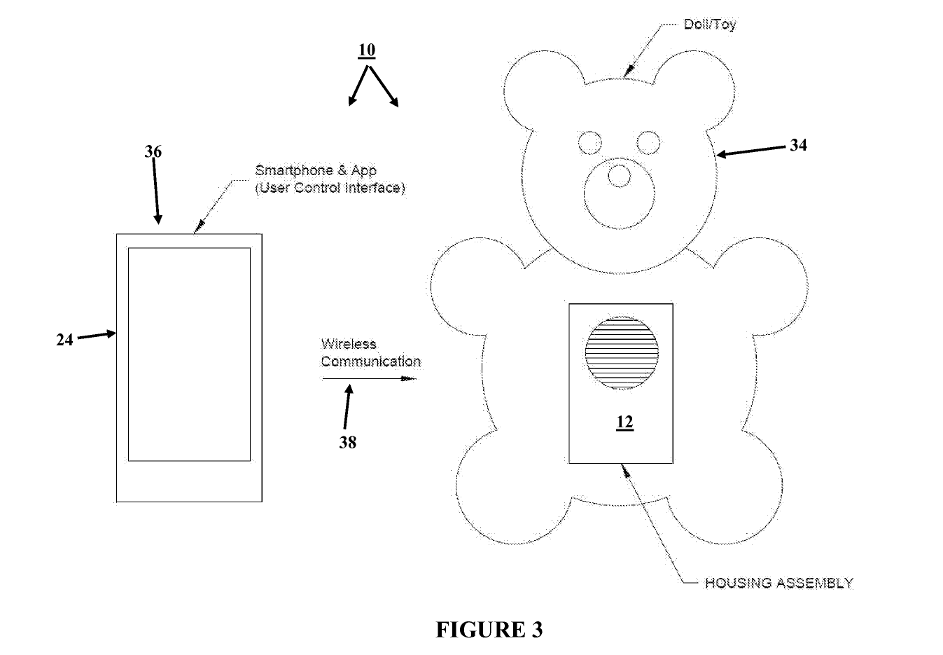

Referring now to FIG. 3, there is shown one preferred embodiment of implementing the time activated audio teaching system 10 in accordance with the present invention into a child's toy 34, shown as a teddy bear. In this embodiment, the user control interface 24 can be a smartphone 36 and mobile application combination connected to the communication module 16 via a wireless Bluetooth communication 38. The user (not shown) can download the mobile application software into their smartphone 36, which provides the user (not shown) with a graphic interface. The user (not shown) uses the mobile application to customize and control the settings of the learning program desired, as will be more fully described below. The customizable settings can include choice of foreign languages to learn and time of day to activate an audio lesson. The user can also specify the number of lessons to activate per day. Lessons can be recordings of native and foreign language words or phrases. The lessons can change every day and advance in difficulty as required by the user. In another preferred embodiment is to use the user's supplied smartphone as the time activated audio teaching system 10. The user can simply download mobile application into the user's smartphone. The mobile application would use the smartphones inherent components as part of the invention and the app's software would provide the remaining user control interface 26.

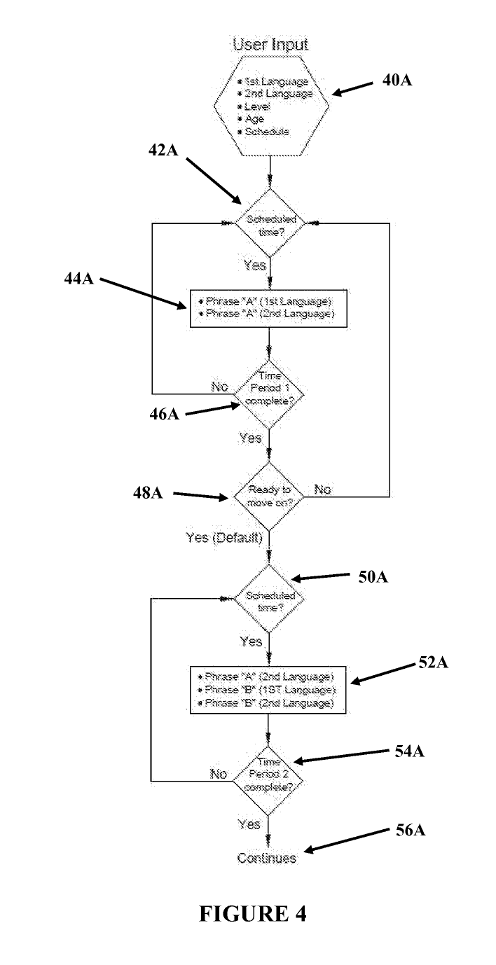

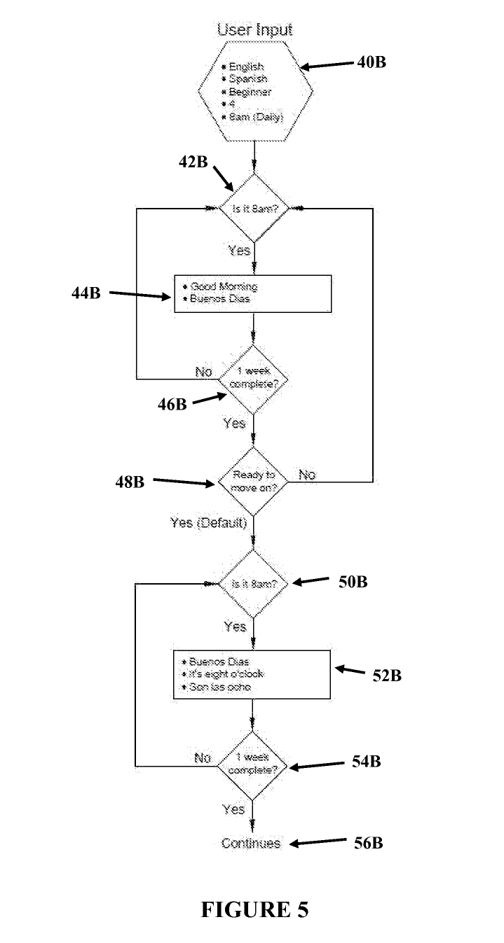

Referring now to FIG. 4, there is shown a flowchart illustrating the steps for a method of audio teaching in accordance with the present invention using a software program supplied by control module 18 utilizing a data library stored in the memory module 20. FIG. 5 illustrates one example of implementing the steps shown by FIG. 4. Turning now to both FIGS. 4 and 5, a user initially specifies in step 40A, using the user control interface 24, an audio lesson by inputting a first and second language, skill level and age of their child or student and the schedule when the audio lesson will be given. By way of example, this may be English, Spanish, beginner level, age 4 wherein the audio lesson is scheduled for 8 AM daily as shown in step 40B of FIG. 5. Next, the control module 18 determines when it is the 8 AM scheduled time as shown in steps 42A and 42B. At the scheduled time, the control module 18 commands the speaker 22 to send an audio of the language phrases, such as “Good Morning” and “Buenos Dias”, that are stored in the memory module 20, as shown in steps 44A and 44B. In accordance with the present invention, steps 42 and 44 will occur daily for a systematic time period as shown in step 46A which could be by example one week as shown in step 46B. The user is now notified by control module 18 whether they would like to proceed to the next lesson or repeat the time period over again (one week) as shown in steps 48A and 48B. If the user does not acknowledge the notification, then by default the next systematic lesson and time period begins at the scheduled time (8 AM), as shown in steps 50A and 50 B.

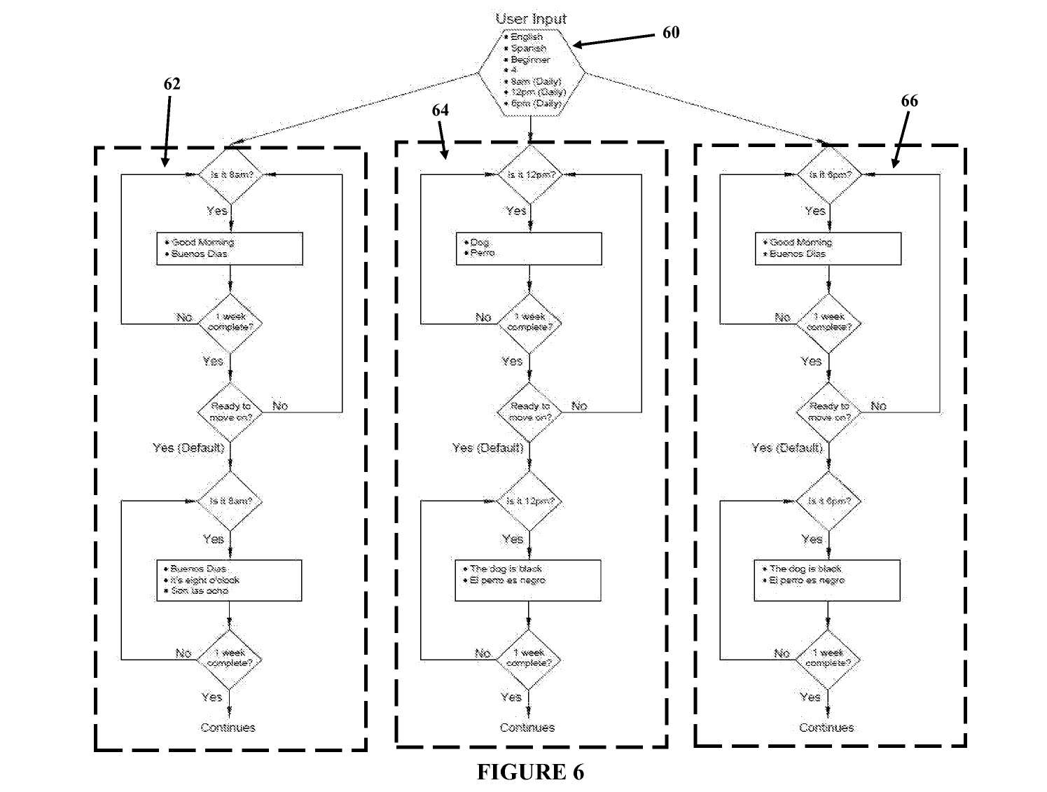

Once again at the user selected scheduled time, the control module 18 commands the speaker 22 to send an audio lesson of the next systematic set of language phrases, such as “It's eight o'clock” and “Son las ocho”, that are stored in the memory module 20, as shown in steps 52A and 52B. Once again, steps 52 and 54 will occur daily for the systematic time period (one week) as shown in steps 54A and 54B. At the end of the second time period the user is notified to proceed to the next systematic lesson or repeat the recently completed time period over again (one week) as shown in steps 56A and 56B. It should be understood that the method as described above repeats itself for as many time periods as desired by the user. Referring now to FIG. 6, there is shown another preferred embodiment in accordance with the present invention wherein a user may schedule more than one lesson throughout the day as shown in step 60. The lessons may be set as desired by the user for any given set of language phrases as shown in flowcharts 62, 64 and 66.

It is to be understood that the present invention is not limited to the embodiments described above, but encompasses any and all embodiments within the scope of the following claims.

What is claimed is:

1. A time activated audio teaching system configured to output audio lessons at specified times, said time activated teaching system, comprising:
a user control interface for providing a schedule of audio lessons to a control module; and
a housing having a power supply for powering and housing said control module, wherein said housing further includes a speaker and memory module, wherein said speaker delivers audio lessons stored in said memory module when a signal is received from said control module wherein a communication module within said housing is used to send said schedule of audio lessons from said user control interface to said control module

2. A time activated audio teaching system as recited in claim 1, wherein said user interface, control module, power supply and speaker is a smartphone utilizing a mobile application stored in said smartphone's memory module for providing said schedule and delivering said audio lessons.

3. A time activated audio teaching system as recited in claim 1, wherein said communication module is a USB port.

4. A time activated audio teaching system as recited in claim 1, wherein said communication module is a wireless transceiver.

5. A time activated audio teaching system as recited in claim 1, wherein said user control interface is a smartphone.

6. A time activated audio teaching system as recited in claim 1, wherein said user control interface is a computer.

7. A time activated audio teaching system as recited in claim 1, wherein said user control interface is a laptop computer.

8. A time activated audio teaching system as recited in claim 1, wherein said user control interface is a tablet computer.

9. A time activated audio teaching system as recited in claim 1, wherein said memory module is a memory chip on a circuit board.

10. A time activated audio teaching system as recited in claim 1, wherein said memory module is a removable memory card.

11. A time activated audio teaching system as recited in claim 1, wherein said power supply are replaceable batteries.

12. A time activated audio teaching system as recited in claim 1, wherein said power supply is a rechargeable battery pack.
